(19) United States
(12) Patent Application Publication
(10) Pub. No.: US 2010/0315228 A1
(43) Pub. Date: Dec. 16, 2010

(54) WEARABLE DATA HUB FOR FIRST RESPONDERS

(75) Inventors: William L. Grilliot, West Milton, OH (US); Mary I. Grilliot, West Milton, OH (US); Michael A. Schubert, Clayton, OH (US)

Correspondence Address: HONEYWELL/HUSCH;Patent Services, 101 Columbia Road, P.O.Box 2245, Morrlstown, NJ, 07962, US

(73) Assignee: Honeywell International Inc., Morristown, NJ (US)

(21) Appl. No.: 12/485,491

(22) Filed: Jun. 16, 2009

(51) Int. Cl. G08B 23/00; G08B 21/00

(52) U.S. Cl. 340/540; 340/693.9

(57) ABSTRACT

A wearable monitoring unit can provide physiological information indicative of a condition of an individual wearing the unit, or, can provide ambient condition alarm related information, from a displaced ambient condition sensor, to the individual to warn the individual as to the existence of the ambient condition. A plurality of physiological conditions associated with the individual can be monitored along with a plurality of different outputs from displaced ambient condition sensors which are in wireless communication with the monitoring unit. All such information can be automatically presented to the wearer, or, forwarded to a supervisory unit.

### FIELD

The invention pertains to information gathering and transmitting devices usable by first responders. More particularly, the invention pertains to electronic units wearable by first responders which can acquire and transmit physiological data relative to the first responder, or receive incoming ambient condition related data so as to warn the first responder as to such conditions.

### BACKGROUND

Various types of first responders, such as fire fighters, or police, at times need to enter regions to address developing dangerous conditions such as fires, or, conflicts. The more extensive the information is as to the subject condition, where it is, what it is and the like, the better prepared the individual will be to address it. Additionally, such information can be important to incident commanders who are trying to assess how best to deploy available resources, personnel or equipment, for example, to address the problem.

While two-way radios have been used to provide information to and obtain information from first responders who are on site at a developing condition, they are neither coupled to the individuals to provide physiological feedback to incident commanders nor are they coupled to regional sensors which can provide information as to developing ambient conditions to the individuals in the region.

There is thus a continuing need to automatically obtain physiological information from first responders in the region of interest as well as to automatically forward information as to developing ambient conditions which regional monitoring systems may be acquiring.

### BRIEF DESCRIPTION OF THE DRAWINGS

FIG. 1 is an overall view of an embodiment of the invention; and

FIG. 2 is a block diagram of an exemplary unit wearable by a first responder.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Embodiments of the invention include an electronic device that is portable/wearable on or by a person such as a first responder or attachable to an object. Such devices will accept, process and communicate (both receive and send) a multitude of data and alerts from appliances or other devices depending upon the type information of interest to the wearer and his/her command staff. For example, fire departments, police departments, military and industrial organizations can all use the same types of wearable devices, or platforms, with different sensors and appliances or features.

Units in accordance with the invention can send and receive data, alerts, and information, process this information, and send this information to appropriate receivers who need to know the information. Such receivers can include, without limitation, the wearer of the device, the wearer's team leader/supervisor, or a local, or, remote incident commander.

Embodiments of the invention can accept inputs from an array of appliances (depending on the application) and can function, in one embodiment, as a central unit for all the appliances in the system. In use, a plurality of individuals wearing such devices might be present in a region in an attempt to respond to a condition, such as a fire or an explosion. Wireless communications from a plurality of such devices could be received at an incident commander's post and provide much more extensive information as to the developing condition than any one individual at a particular location would be able to provide.

Embodiments of the invention could function as adaptable and easily re-configurable platforms for receiving and processing signals output from a variety of sensors. In an aspect of the invention, first responder safety and health can be enhanced as they respond to a broad spectrum of incidents. Recent studies show that the majority of fire fighter deaths are not due to fires but issues related to the stress and health status of the fire fighters who are responding.

In another aspect of the invention, such devices or platforms would be able to receive biological sensor inputs (blood pressure, heart rate, respiration rate, body temperature, blood oxygen level) from the first responder wearing the device, and, be able to determine if alarms are necessary based upon the that type of sensor outputs being received. Such alarms could be transmitted to the incident commander or to other team members. The system would also be able to receive inputs from external, ambient condition, sensors (temperature & rate of increase, smoke, fire, lethal gases, toxins, biohazards, etc.) and transmit alarms to first responder and the incident commander.

In yet another aspect of the invention, such devices could incorporate an ability to respond to additional sensor inputs without any need to add additional radio transmitters or processing hardware. Such flexibility is advantageous in that the devices are not being constrained to a single solution or implementation for different features. In another aspect of the invention, the units could be configured according to the needs and budgets of the various users.

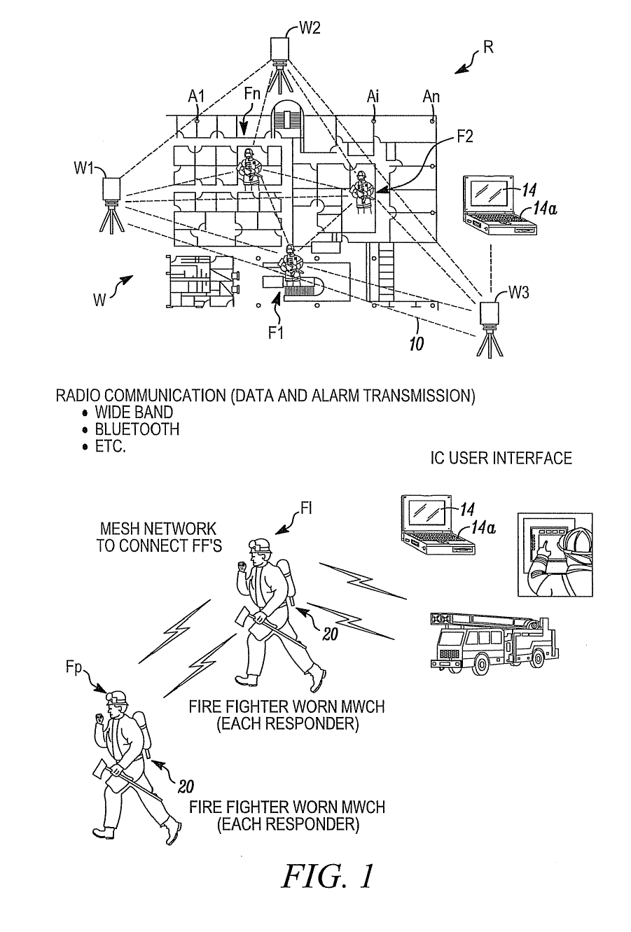

FIG. 1 illustrates a region R which can be monitored by a plurality of ambient condition sensors, such as A1, A2 . . . An. Such sensors can include smoke sensors, flame sensors, gas sensors, thermal sensors, toxin or biological sensors or radiological sensors all without limitation. Sensors, such as Ai can be in wired, or wireless communication with a regional monitoring system indicated generally at 10. As those of skill will understand, the system 10 can determine, based on signals received from the sensors Ai, the existence of a dangerous, or a developing condition, for example, a fire, a concentration of a dangerous gas, or a biological hazard. Such determinations can be made available at a control panel of the system 10 which can be observed by first responders, and or their incident commander(s).

However, when the first responders, such as fire fighters Fi enter the region R to try to suppress or control the condition, they no longer are able to view the display/control panel of system 10, which might be at the front door of the region R for example. Additionally, their situational or incident commander will no longer be in eye contact with his/her personnel.

In accordance with the invention, a plurality of transceiver units Wi can be located to implement a mesh-like local wireless network W throughout the region R. For example three units W1 . . . W3 can be provided to cover the region R and provide location information, as discussed subsequently relative to first responders in the region R. Exemplary types of networks could include those based on wide band, bluetooth or similar types of technologies, all without limitation.

A commander's situational console including a graphical user interface 14, and associated control circuits and control software 14a, can be coupled, wired or wirelessly to the network W. The network W can also provide audio and/or visual communications between the first responders Fi or between the first responders Fi and the interface 14.

Information as to location of the personnel F1 . . . Fn in the region R can be displayed at the interface 14 for use by the incident commander. Situational, ambient condition, information, from sensors Ai in the region R and monitoring system 10 can also be displayed at interface 14.

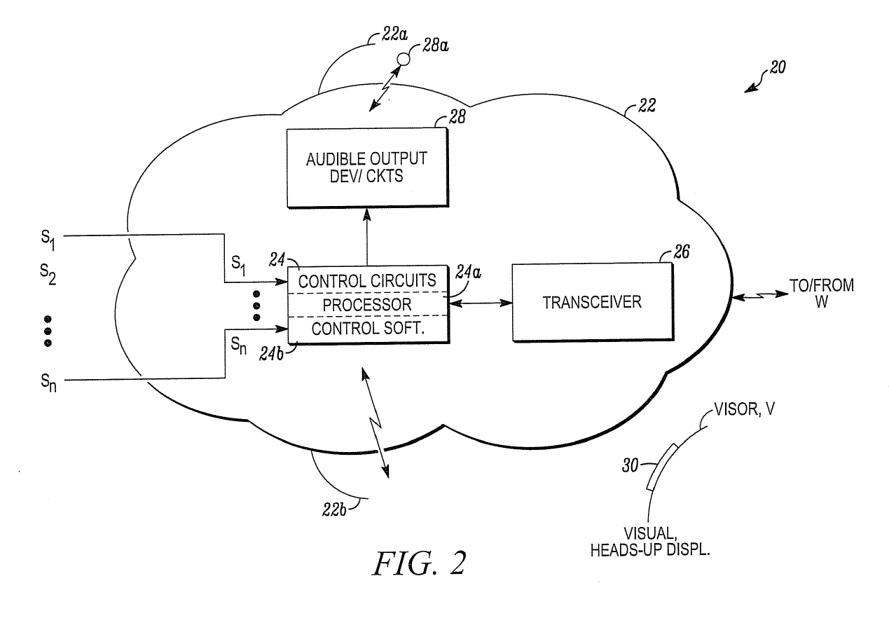

Determinations as to the types of ambient conditions and their respective states, such as pre-alarm, or alarm, can be made by system 10 or at the circuitry 14a and presented on the graphical user interface 14. This information can also be broadcast into the region, via network W to a plurality of communications units 20, see also FIG. 2, which can be carried or worn by the first responders Fi.

The units 20 have a housing 22 and are attached to first responders Fi by straps, belts, hooks 22a,b all without limitation. The units 20 include control circuits 24 which can be implemented, in part by a programmable processor 24a and associated control software 24b. It will be understood that the control software 24b, as well as that associated with the incident commander's console 14, 14a would be stored on a local computer readable storage medium, preferably in executable form for use by the associated processor such as 24a, 14a.

Unit 20 can also include a plurality of physiological sensors S1, S2 . . . Sn which are coupled to the first responder who is carrying that respective unit. These sensors, which could include blood pressure, heart rate, respiration rate, core body temperature, blood oxygen level sensors, or orientation sensors, all without limitation, provide real-time feedback as to the physical condition of that first responder to the control circuits 24. Circuits 24 can evaluate the physiological indicia and can communicate that information via transceiver 26 and network W to the incident commander's console 14, 14a.

The unit 20 can also include circuitry and an audible output device 28 to provide real-time feedback to the first responder via speech, or other type of audible alarm. Device 28 could also include a vibrator unit to signal the first responder in addition to audio, as well as a siren or other emergency indicator to assist in locating that individual. In one embodiment, a wireless ear piece 28a can be coupled to output circuits 28 to provide the audio and/or speech to the individual.

Unit 20 can also include a visual output device 30, coupled to control circuits 24, which might be implemented as a wireless heads up display on the responder's visor V. Unit 20 can thus provide to the first responder visual and audible feedback as to developing dangerous conditions, or alarms, in the region R as well as information from the incident commander's console 14, 14a and physiological information as to that individual's condition. It can also feed the physiological information to the commander's console 14, 14a. The commander can, in response to information as to the responder's physical condition order him/her out of the region R to seek treatment as appropriate.

It will be understood that the units 20 can receive different types of sensor related signals depending on the monitoring system 10 as well as various pre-alarm or alarm related messages to present to the first responder graphically or audibly as appropriate. While the above has been described in the context of fire fighting, it will be understood that the invention is not so limited. It can be incorporated in various forms into other types of systems such as enforcement (police), environment clean-up, military and the like all without limitation.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A communications system comprising:
a wearable, personal communications unit which includes:
a housing, the housing has attachment elements which engage a respective individual;
at least one transceiver carried by the housing;
control circuits in wireless communication with the transceiver; and
a graphical display and user interface coupled to the control circuits where the control circuits receive physiological information, associated with the individual, as well as information from a plurality of ambient condition sensors in wireless communication with and, displaced from the transceiver, and where such information can be presented on the display indicative of an alarm indicating physiological condition, associated with the individual, or an alarm indicating ambient condition endangering the individual.

2. A system as in claim 1 which includes a plurality of spaced apart regional transmitters which can provide wireless coverage in a selected region being monitored by the ambient condition sensors.

3. A system as in claim 2 which includes a situational control unit in communication with at least one member of the plurality of regional transceivers.

4. A system as in claim 2 which includes a regional monitoring system coupled to the ambient condition sensors.

5. A system as in claim 4 where the regional monitoring system is coupled to a situational control unit in communication with at least one member of the plurality of regional transceivers.

6. A system as in claim 4 which includes a plurality of physiological sensors coupled to the control circuits.

7. A system as in claim 6 where the physiological sensors are selected from a class which includes at least blood pressure sensors, cardiac sensors, respiratory sensors, thermal sensors, oxygen sensors and orientation sensors.

8. A system as in claim 7 where the ambient condition sensors are selected from a class which includes at least thermal sensors, gas sensors, biological sensors, smoke sensors, fire sensors, and radiological sensors.

9. A system as in claim 6 which includes circuitry to present on the graphical display alarm indicating information responsive to outputs from various of the ambient condition sensors.

10. A system as in claim 9 which includes a situational control unit in communication with at least one member of the plurality of regional transceivers where the situational control unit can communicate with the control circuits at least one of verbally or visually.

11. A system as in claim 10 which includes a plurality of substantially identical personal communications units where each of the units can communicate with the situational control unit via the network.
